(19) United States
(12) Patent Application Publication
(10) Pub. No.: US 2020/0329679 A1
(43) Pub. Date: Oct. 22, 2020

(54) FILTRATION SYSTEM FOR USE WITH AN EGG WASHER OPERATION FOR EXTENDING BOTH EFFICIENCY AND LIFE CYCLE OF A VOLUME OF WASH WATER INCLUDING CLEAN-IN-PLACE CLEANING OF THE WASHER AND WATER DISPOSAL/REFILL OPTIONS

(71) Applicant: Moba Group B.V., Barneveld (NL)

(72) Inventors: Jonathan D. Robinson, Swartz Creek, MI (US); Robert Grant Baguley, Lock Haven, PA (US)

(21) Appl. No.: 16/851,210

(22) Filed: Apr. 17, 2020

Related U.S. Application Data
(60) Provisional application No. 62/836,128, filed on Apr. 19, 2019.

(51) Int. Cl. A01K 43/00; B01D 36/02; B01D 33/06; B01D 29/00; B01D 33/72; B01D 37/04; B08B 3/02; C02F 1/00; B01D 29/90

(52) U.S. Cl. CPC A01K 43/005; B01D 36/02; B01D 33/06; B01D 29/0097; B01D 33/72; C02F 2103/002; B08B 3/02; C02F 1/001; B01D 29/90; B01D 2201/16; B01D 37/04

(57) ABSTRACT

A system for filtering and recirculating a wash fluid associated with a piece of equipment. An outlet line extends from a drain location of the piece of equipment for communicating the wash fluid from the equipment to a first stage particulate removal filter. A further conduit extends from an outlet of the first stage filter for communicating the wash fluid to a first tank. A second stage filter is in communication with a first outlet extending from the first tank for continuously redirecting a subset portion of the fluid through the second stage filter. A return conduit extends from an outlet side of the second stage filter which is communicated with a second outlet extending from the first tank at a rejoining location for redirecting a recombined fluid back to an intake line for redelivery to the piece of equipment.

### CROSS REFERENCE TO RELATED APPLICATIONS

The present application claims priority from U.S. Ser. No. 62/836,128 filed Apr. 19, 2019.

### FIELD OF THE INVENTION

The present invention relates generally to filtration systems, such as which are used in egg washer operations for the purpose of cleaning shell eggs as they are passed through the washer. More specifically, the present invention discloses a filtration system, separated from the egg washer by drain and return fluid connections, and by which remote multi-stage filtering of the used wash water allows for continual recycling and reuse. The ability to extend the use cycle of a given volume of wash fluid reduces the expense of chemical additives to the wash water, such as are required to combat foaming which can result from the inability to remove proteins and bacteria from the wash water. The system includes additional fluidic connections to the washer equipment in order to facilitate any of clean-in-place or rinse cycle operations, such as during periods of maintenance, and again by which the effective life cycle of the wash fluid can be maximized.

### BACKGROUND OF THE INVENTION

The prior art is documented with examples of conventional egg washer, an example of which is depicted at 10 in FIG. 1 according to the Prior Art. As will be further described with reference to succeeding FIGS. 2A-8B, the conventional egg washer typically includes a built in water circulation and filtration system for collecting, filtering and redirecting to the various egg spray bars which are arrayed at locations over the egg conveying and candling spool bars.

As shown in FIG. 1, a conventional egg washer is generally shown at 10 and, as further shown in FIGS. 2A-2C and 3, as a dual washer configuration 10/10′. In each instance, the washers include a collection of fill lines shown at 12/14 and 16/18 in FIG. 3 associated with the washers. Drains 20/22 and 24/26 extend to a collection pit (not shown). Additional features include fluid recirculation lines (see at 28 and 30 in FIG. 1), pumps 32 and fluid collection reservoir (hidden from view however located at an underneath interior location of the washer).

In a preferred embodiment, the tanks that store the water for egg washing are located below egg conveying spool bars and overhead spray bars (not shown but understood to form components of an existing egg washer operation). The internal reservoir of water is pumped to the upper half of the washer and, following issuance from the spray bars, is caused to drain back into the lower tanks before being crudely filtered and recirculated by the pumps for reuse.

FIGS. 2A-2C present a series of schematics of another version of a typical egg washer, not dissimilar to that shown in FIG. 1. An egg dryer 34 is illustrated in successive positioning relative to the egg washer, and interconnected by such as a conveyor including width extending end and spaced spool bars. A power supply (such as three-phase 450V with ground) can also be provided for powering each of the washer and dryer assemblies.

A number of disadvantages of incorporating the washer tanks within the egg washer include exceeding the number of utility connections that have to be completed during installation, such as in particular applications in which the pair of washers 10/10′ are integrated into an associated egg conveying and grading line operation and in order to maintain production volume given the provision of a single washer can be a bottleneck location during operation. As shown, the most complex installations require up to eight boiler connections, four drains where a collection pit needs to be installed to drain the water, four fill connections, and a power supply for operating four large pumps in order to maintain constant circulation and reuse of the fluid.

FIG. 2B illustrates a side plan view of the washer arrangement of FIG. 2A and showing the provision of underside wash fluid collection reservoirs 38 along with circulation lines 40/42 and drains 42/44. FIG. 2C is a ninety degree rotated end view of the dual washer arrangement of FIG. 2A, the washers each further depicting individual rotary filters 48/50 (see also FIG. 2A). Also shown in FIG. 2B in phantom are individual exhaust locations 50/52 which extend to a common conjoining location 54 such as which can incorporate an exhaust fan (not shown).

FIG. 3 presents an environmental illustration of a conventional egg washer according to the Prior Art and similar to that depicted in FIG. 1, including the multiple (e.g. four) fill line connections again shown at 12-18, along with a like number of drain connections 20-26 consistent with a conventional assembly. FIG. 4 is a further environmental illustration of a plurality of boiler connections (see at 56 and 58) associated with each end of the egg washer 10 for heating and maintaining a desired temperature of the wash water. As is further noted, the cost associated with installing hot water lines from a central boiler to the washer, combined with the necessity of wrapping the lines in an insulating material (at 60) to prevent burns to the operator, renders the installation more difficult to clean and maintain. Also shown is a pull out tray 62 for removing broken eggs and shell fragments (at 64).

FIG. 4 is an environmental illustration of one of the multiple electrical pumps 32 (see as also shown in FIG. 5) which are required for the water filtration and circulation system integrated into the washer construction according to the known art. In one known installation, each end of the washer can include one or more 10-20 HP water circulation pumps for circulating the water through the washer (including reservoir), heat exchanger 66, and strainer filters 68. As previously noted, the requirement of integrating all of the wash, reservoir, pump, filter and recirculation aspects directly into the washer renders it more expensive and complex.

FIG. 5 presents a known filtration technique associated with a convention egg washer, such including the use of a rotary filter (see as shown in FIG. 4) as well as any strainer type of filter (further identified at 68). As is further shown, the use of a rotary filter results in a fairly expensive and customized addition to the washer, whereas the use of too coarse a strainer results in the propensity to clog in response to collection of the broken eggs, this affecting the fluid flow to the spray nozzles. In the instance of too fine a screen or filter, clogging occurs too quickly resulting in creating additional pressure drop, reducing flow to the nozzles thereby reducing the cleaning effectiveness of the system.

FIG. 6 is an illustration depicting widespread clogging of spray nozzles 70 associated with the conventional egg washer, and which often results from the shortcomings of current washer filtration options. Also depicted are candling bars 72 which support a volume of conveyed eggs 74 between inlet and outlet locations of the washer 10.

Subsequent FIGS. 7, 8A and 8B illustrate additional shortcomings of existing filtration systems integrated directly into the shell egg washer, such including clogging of screens (see pairs of screens 76/78, 80/82, and 84/86 in FIG. 7). Each washer section includes one or more screens to collect egg shell and debris as depicted in the illustrated embodiment so that these do not sit in the lower located internal washer reservoir tanks. The screens are further required to prevent larger sized egg shell fragments from clogging the pumps, tanks and strainers as depicted in the various prior art views.

This clogging of the filters results in the continual flow of water through the aggregating egg debris 64 (see as previously shown in FIG. 4 and further referenced in respect to selected screen 86 in FIGS. 8A and 8B), which contributes to further contamination of the enclosed reservoir of washer water. As is further known, such clogging is accelerated in instances in which larger pieces of egg shell, yolk, and albumen (including both eggs broken while supported on the spool conveyor as well as whole eggs which can fall from the conveyor), these being caught in the filtration system and by which the filters/screens and pumps can become clogged and, in fairly short order, rendered useless.

As a reflection of current levels of efficiency of egg washer filtration, applicable USDA rules further require that the volume of washer fluid contained within the closed reservoir of the washer or other equipment be dumped after four hours of operation and the washer reservoir refilled with fresh water. Another aspect of known egg washer operation includes the requirement of dosing the washer with chemicals in order to control instances of foaming of the water as a result of the buildup of proteins and bacteria (these being in particular prevalent in the presence of excessive egg debris). The expense of these chemicals, being additional to the cost of the replacement water, is further compounded by their elevated usage requirements as the soil level in the wash water increases. Existing washer filtration assemblies require continual cleaning and replacement of the washer reservoir (typically every four to five hours of operation as stipulated by existing USDA rules).

Additional disadvantages of the current wash system can also include the requirement of providing extra on-site water treatment outside of the washer cycle, such as in order remove solids and other contaminants outside of the capability of the built-in washer filters/strainers, and before the water can be refilled into the washer or returned to the environment.

Other aspects of built-in filtration systems can include the requirement of providing numerous utility connections (i.e. including piping arrangements) and controls distributed to the washer/equipment which are expensive to install and maintain. The degree of filtering at the washer is further limited to the available space, with lower tech solutions such as the installation of strainers providing the primary method of filtration. Furthermore, higher tech solutions such as installing rotary drum filters can be prohibitively expensive in that they are required to be custom fitted to the given application and are still usually found to be inadequate in operation.

### SUMMARY OF THE PRESENT INVENTION

The present invention discloses a system for filtering and recirculating a wash fluid associated with and separate from a piece of equipment, such as not limited to an egg washer assembly. As will be described in detail, the system provides for more effective filtration and reconditioning of a given volume of fluid utilized in the egg washing operation, thereby permitting a more simplified egg washer construction not requiring the integrated filtration tanks, and along with permitting extended reuse of a volume of wash water resulting in both reduced chemical/anti-foaming dosing volumes as well as reduced disposal expenses by allowing for extended use of a given volume of washer fluid.

The present system and assembly includes an outlet line extending from a drain location of the piece of equipment (e.g. egg washer) for communicating the dirty wash fluid from the equipment to a first stage particulate removal filter. A further conduit extends from an outlet of the first stage filter for communicating the wash fluid to a first tank. A second stage filter is provided in communication with a first outlet extending from the first tank for continuously redirecting a subset portion of the fluid through the second stage filter. A return conduit extends from an outlet side of the second stage filter which is communicated with a second outlet extending from the first tank at a rejoining location for redirecting a recombined fluid back to an intake line for redelivery to the piece of equipment.

Additional features include the first stage filter further comprising at least one of a rotary filter and a parabolic screen filter. A wash water sending pump is located between the drain location and the first stage filter.

The first tank further includes a wash water balance tank having a tank level indicator, a temperature sensor and a PH/conductivity/turbidity chemical sensor. The first outlet from said first tank further includes first and second subset outlets, with the first subset outlet communicating fluid to an outlet side of the second stage filter and the second subset outlet redirecting wash fluid through a filter pump in communication with an inlet of the second stage filter.

The second subset outlet further includes a filter selection valve positioned on an outlet side of the second stage filter, the first subset outlet communicating with the filter selection valve. A second filtered water balance tank is provided in communication with an outlet of the filter selection valve.

Additional features include a third stage filter located on an outlet side of the filter selection valve prior to the second filtered water balance tank. A tank selection valve is provided at the rejoining location, an outlet of the rejoining location communicating the recombined fluid to a wash water return pump.

A wash water heat exchanger located at an outlet of the wash water return pump, the heat exchanger being in communication with the intake line extending to the inlet location of the equipment. The piece of equipment further includes a shell egg washer having a fluid network of spray bars extending between the intake and outlet lines. The shell egg washer further includes a clean in place architecture which is communicated with the intake line for cleaning an interior of the shell egg washer.

Other features include a clean in place supply line in combination with a clean in place valve extending in a second intake line extending parallel to the first input line to the egg washer. A plurality of supply circuit valves are associated with the clean in place architecture and extend between the second washer intake line and a clean in place return line extending to a clean in place return tank select valve in communication with the second filtered water balance tank.

The clean in place architecture further includes a plurality of spherical shaped elements in communication with the clean in place supply line within the washer for distributing fluid in a non-operational maintenance phase to clean an interior of the washer. A detergent additive is provided at one of the first and second tanks.

The filtered water balance tank further includes each of a tank level sensor, a temperature sensor and a PH/conductivity/turbidity chemical sensor. Finally, each of the wash water balance tank and the filtered water balance tank further includes a chemical supply valve and a potable water supply valve communicating with an inlet location.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of a conventional washer according to the Prior Art;

FIGS. 2A-2C present a series of schematic views of a typical egg washer such as shown in FIG. 1;

FIG. 3 is an environmental illustration of a conventional egg washer and including multiple fill line connections and drains;

FIG. 4 is a further environmental illustration of boiler connections associated with each end of the egg washer and for heating and maintaining a desired temperature of the wash water;

FIG. 5 is an environmental illustration of one of the multiple electrical pumps which are required for the water filtration and circulation system integrated into the washer construction according to the known art and further depicting known filtration techniques associated with a convention egg washer, such including the use of a rotary filter, as well as a strainer filter;

FIG. 6 is an illustration depicting widespread clogging of spray nozzles associated with the conventional egg washer and which often results from the shortcomings of current washer filtration options;

FIGS. 7, 8A and 8B illustrate additional shortcomings of existing filtration systems according to the Prior Art integrated directly into the shell egg washer, such including clogging of the screens and the continual flow of water through the egg debris, resulting in further contamination of the wash water;

FIG. 9 is an illustration of a simplified egg washer forming one component of the present invention and by which the Prior Art arrangement of heat exchangers, tanks, filters, and other utilities are removed in favor of a simplified lower gravity drain and outlet pipe which communicates the used/contaminated water with a remote multi-stage filtration and reconditioning system, following which the water is re-delivered to the washer via an inlet pipe in communication with the egg spray bars or, alternatively, the separate clean in place architecture incorporated into the washer interior;

FIG. 10A is a perspective illustration of a parabolic screen portion and including a separate localized drainage port incorporated therein apart from an interconnected outlet line and a lower waste removal location;

FIG. 10B is an illustration of one possible combination of components integrated into the water filtration reconditioning system including the parabolic screen portion of FIG. 10A and such as which can be combined into a skid remotely located from the washer (and interconnected therewith by the outlet and return conduits noted in FIG. 9);

FIG. 11A is a diagrammatic illustration of a wash water circulation, filtration, reconditioning and re-use system according to one non-limiting variant;

FIG. 11B is a modified diagrammatic illustration similar to that shown in FIG. 11A and depicting an additional clean-in-place function in use with the remote multi-stage filtration and reconditioning system according to further variant;

FIG. 11C is a further modified diagrammatic illustration similar to that shown in FIG. 11B and depicting additional monitoring features associated with each of the wash water balance tank and filtered water balance tank;

FIGS. 12A and 12B present both environmental assembly and related schematic illustrations of a further embodiment of the present invention utilizing a dual tank clean in place system; and

FIGS. 13A-13C provide a collection of illustrations, including each of a schematic (FIG. 13A) of a clean in place (CIP) wash architecture incorporated into the washer and which can include a CIP supply line connecting to a network of piping, a sectional perspective (FIG. 13B) depicting the CIP supply line extending from a CIP valve which connects to the network of piping that can also include sprayers (see FIG. 13C) for the cleaning in place of brushes and inside components and walls of the washer.

### DETAILED DESCRIPTION OF THE PREFERRED EMBODIMENTS

Given the above description of existing washer assemblies with integrated filtration sub-assemblies, the present invention discloses a filtration system which can be separated from the egg washer by drain and return fluid connections, and by which the limited capabilities of prior art built-in water filtration systems are substituted by a remote multi-stage filtration and replenishment system of the used wash water, thereby allowing for continual recycling and reuse. The present system further reduces the expense of chemical additives to the wash water (this in the prior art usually requiring a full dosage of additives to accompany each replacement volume of wash water), and such as required to combat foaming and which can result from the inability to remove proteins and bacteria from the wash water.

As will be also described, the system includes additional fluidic connections to the washer equipment in order to facilitate any of clean-in-place or rinse cycle operations, such occurring during periods of maintenance, and by which the effective life cycle of the wash fluid can be maximized.

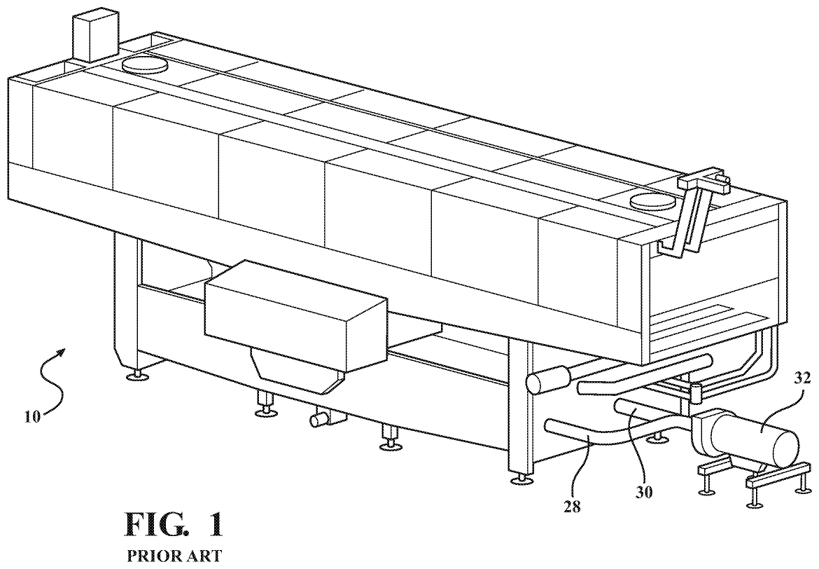

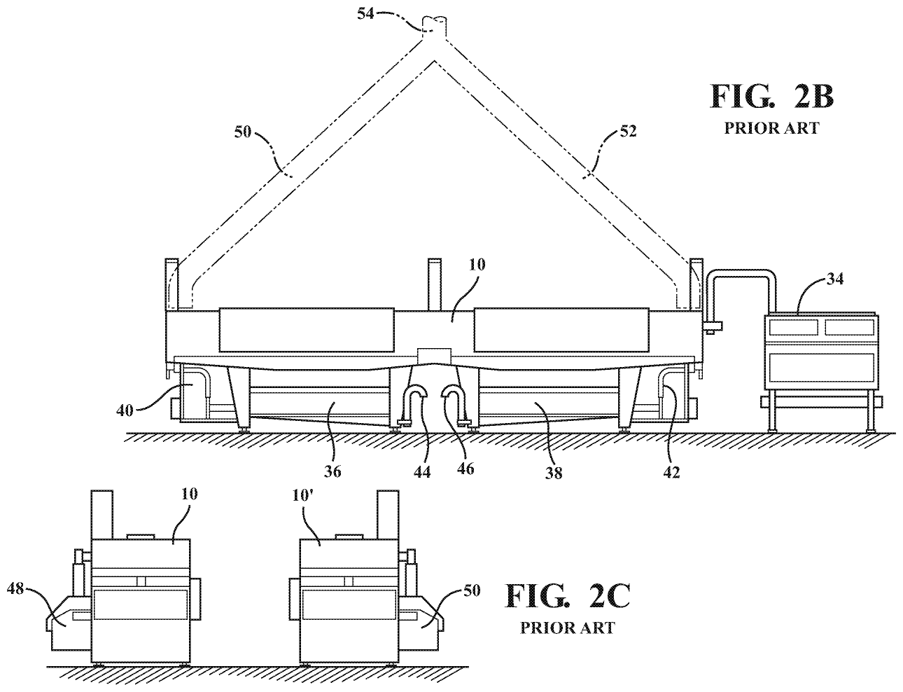

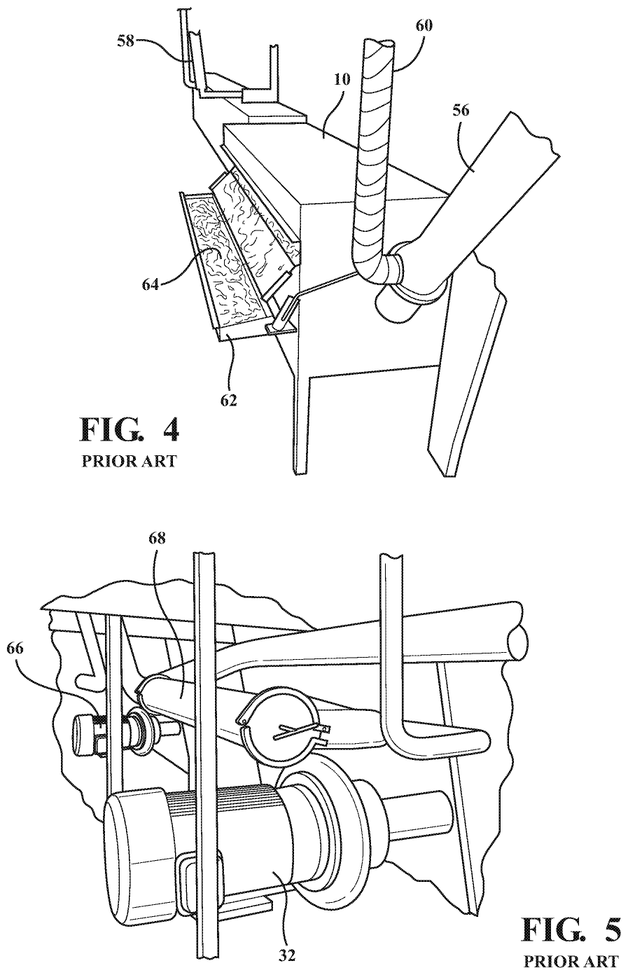

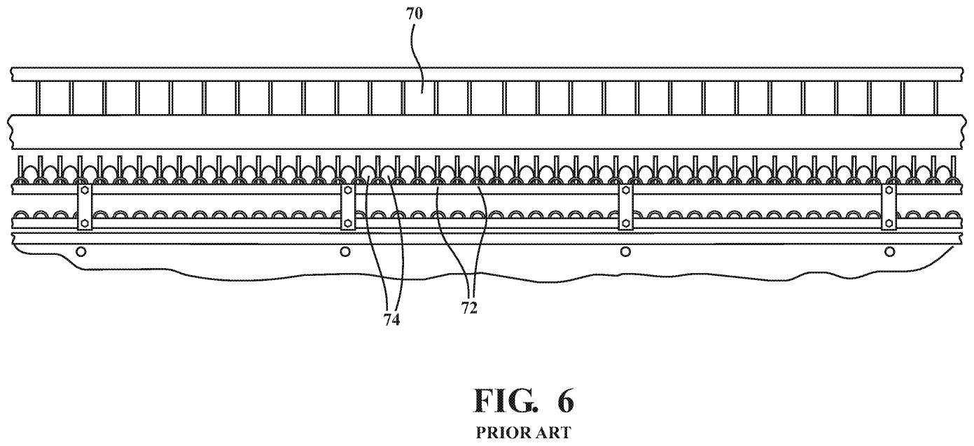

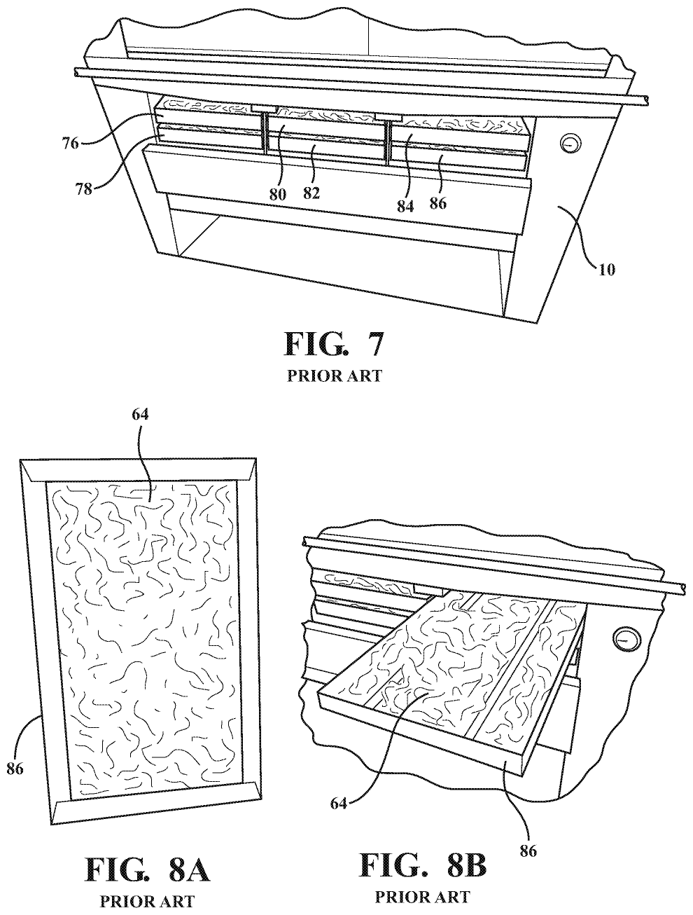

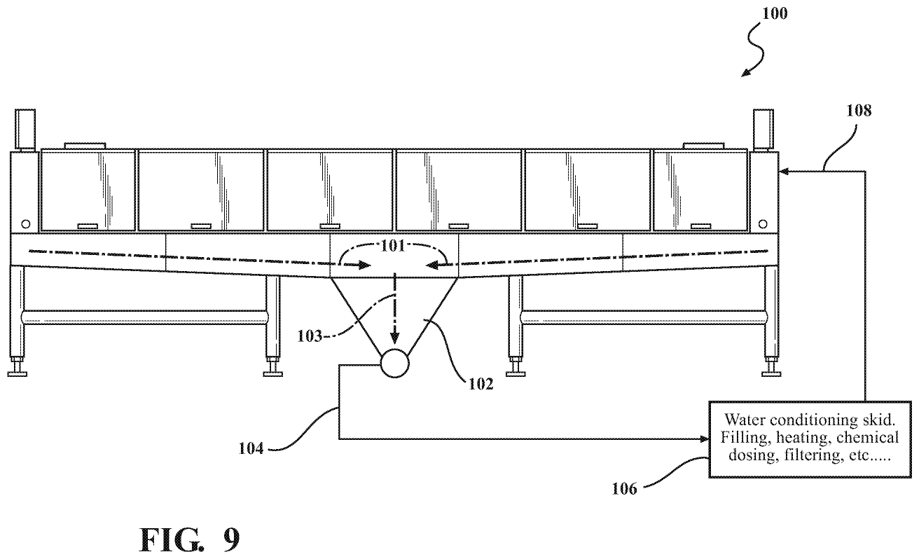

Proceeding to FIG. 9, an illustration, generally at 100, is shown of a simplified egg washer forming one component of the present invention and by which the Prior Art arrangement depicted in FIGS. 1-8A of heat exchangers, tanks, filters, and other utilities are removed in favor of a simplified lower gravity drain 102 and outlet pipe 104 feeding the used/contaminated wash water (see in phantom by directional arrows 101 and 103) to a separate skid or other remote located filtration assembly. This is further represented at 106 and to which the outlet pipe 104 communicates the used/contaminated water. Following filtration/reconditioning treatment, the water is then routed via a return pipe 108 back to the washer for reuse through the associated washer spray nozzles or clean in place nozzles for cleaning out the interior of the washer during servicing thereof.

As will be described, the incorporation of the separate filtration/conditioning system (or skid 106) provides for each of filling, heating, chemical dosing, filtering and redelivering back to the washer a continuous source of quality wash water exceeding the quality of traditional built-in washer reservoirs at any stage of their respective life cycle. Additional advantages of the remote filtration skid/assembly of the present system include the ability to fabricate a less expensive washer by virtue of it not requiring the built-in capabilities associated with the prior art designs of FIGS. 1-8A, as well as providing simpler utility installation requirements for the customer and providing for easier cleaning and maintenance.

Additional advantages include providing for a higher degree of filtration by virtue of not being limited by the equipment/washer physical properties. Other advantages include the tanks and pipes located on the conditioning skid being insulated to improve heating efficiency, such often not being possible on the washer without sacrificing clean-ability. As will be further described, the present skid assembly can be configured as an option dual tank configuration providing clean-in-lace functionality for the equipment during maintenance periods.

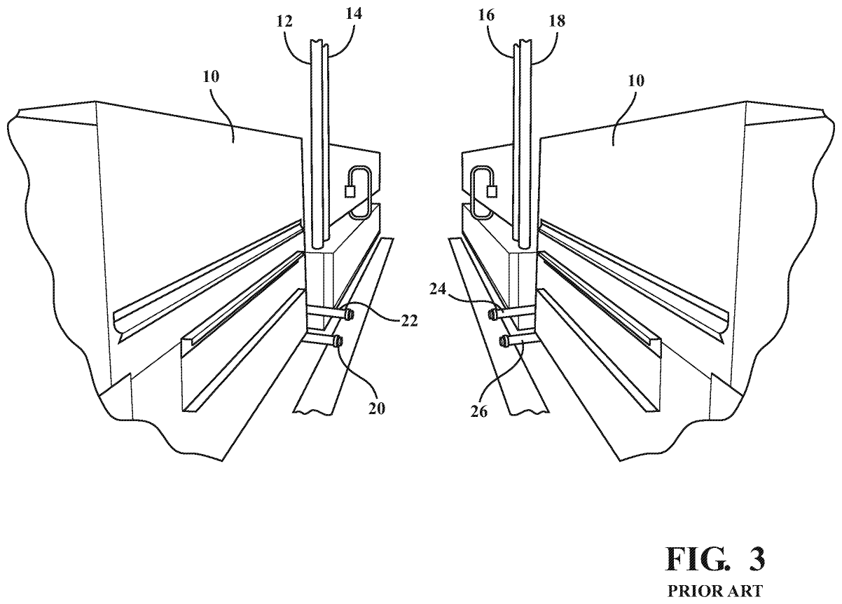

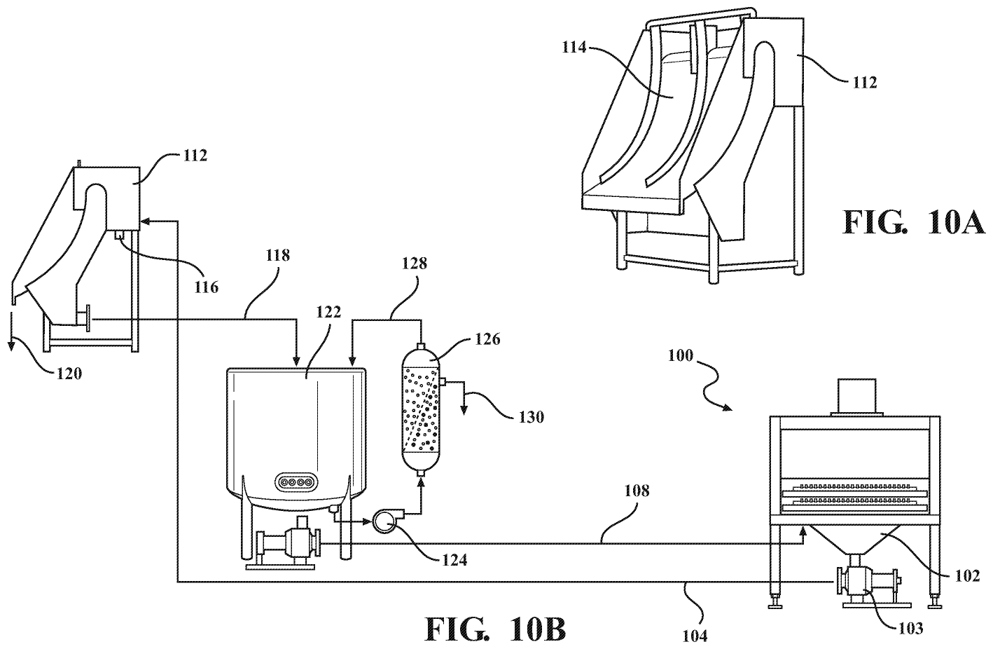

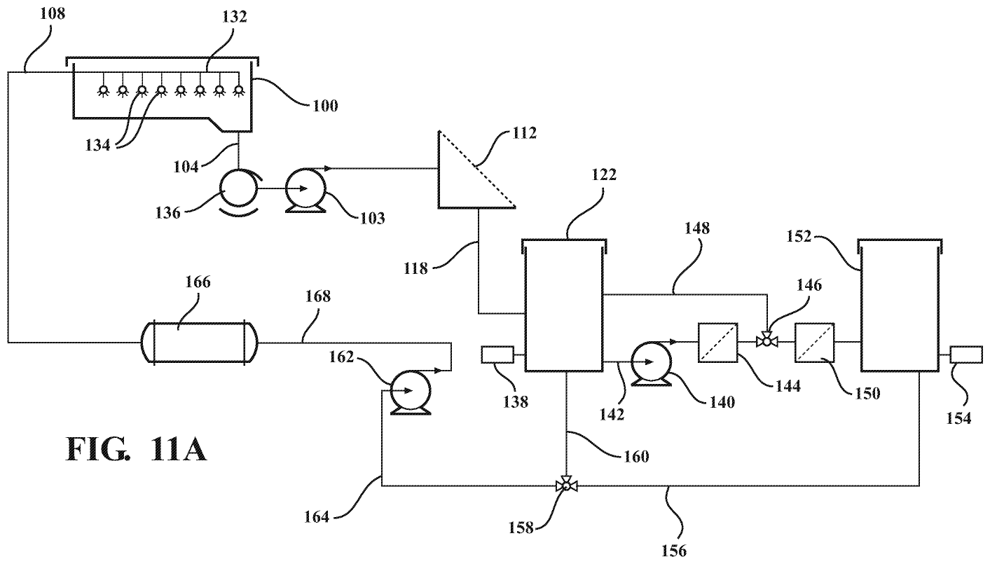

FIG. 10B is an illustration of one possible combination of components integrated into a water filtration reconditioning system (such as again referenced by the skid 106 in FIG. 9) and such as which can be assembled at any location remote from the washer (and interconnected therewith by the outlet pipe 104 and return conduit or pipe 108 extending to and from the washer 100 as also noted in FIG. 9). As will be described, and without limitation, the water conditioning skid can include any combination or arrangement of interconnected components which provide for filling, heating, chemical dosing, filtration at a remote location apart from the redesigned washer 100. The arrangement of tanks and pipes on the conditioning skid 106 (and as further depicted in FIGS. 10-12) can also be insulated to improve efficiency and without the concerts of sacrificing clean-ability by insulating the boiler connections at the washer as is shown in the Prior Art depiction of FIG. 4).

The washer, as redesigned at 100 in comparison to that depicted at 10 in the Prior Art, is simplified to remove the extra fluid conduits, pumps and filters for filtering the wash water in favor at the wash location, in favor of a simplified gravity drain feeding the dirty/soil contaminated water to the outlet pipe 104 for delivery initially to screening device and sump (such as for initially removing very large shell pieces and other soil contaminants). As shown in FIG. 10, the washer 100 can, apart from the gravity drain 102, include a single large volume outflow pump 103 for directing the collected dirty fluid along with the entrained particulates to the remote skid located filtration components. It is also envisioned in certain applications that the piping architecture can permit initial redirection of the drained fluid to an initial rough filtration step without a preliminary pump and, following this, the rough filtrated water can be subsequently pumped to the remote (separate room or separate skid) located system (such as again at 106) for additional conditioning, (which can again include any or all of filling, heating, chemical dosing, and filtering) and prior to redelivery back to the reconfigured washer 100.

As further shown in FIG. 10A, an initial remote filtration stage can include a parabolic screen 112 or equivalent rough filter, such as again located at any point between the drain outlet 104 located at the underside of the washer 100 and the subsequent fine filtration and water reconditioning components. A sump or other suitable fluid pump can be located either before or, typically following, the initial screening/rough filtration component for advance and fairly lower cost removal of the largest contaminants (can include larger shell particles or even whole eggs).

The parabolic screen portion of the filter is further depicted at 114 in FIG. 10A and, referring again to FIG. 10B, includes a separate localized drainage port 116 incorporated therein apart from an interconnected outlet line 118 and a lower waste removal location 120. It is also envisioned that other equivalent first stage filtering component can be substituted or added to that shown at 112 for removing the largest dirty water contaminants prior to succeeding filtration and reconditioning/retreatment steps.

As further depicted in FIG. 10B, the outlet 118 of the initial our rough stage filtration (e.g. again parabolic screen 112) communicates the semi-filtered effluent to a wash water balance tank 122, this in turn being connected by an outflow line situated pump 124 with an ultra filter 126 for additional stage/detailed contaminant removal. A further ultra filter outlet line 128 redirects the filtered material back into the balance tank 122, along with the waste from the filter 126 being removed at 130.

Without limitation, the present invention contemplates a variety of potential filtration options which can include varying degrees of particulate or component filtering. As such, the terms “micro”, “nano” or “ultra” can reference different filtration levels or degrees of removal. It is also noted that any given filter, such as without limitation ultrafiltration (UF) filter 126, can be designed to filter out undesirable components from the wash water including such as bacteria, proteins and fats, the removal of which helps to limit the need for additional and expensive anti-foaming detergents or other required additives prior to redirecting the filtered and reconditioned fluid back to the washer 100 via the inlet line 108.

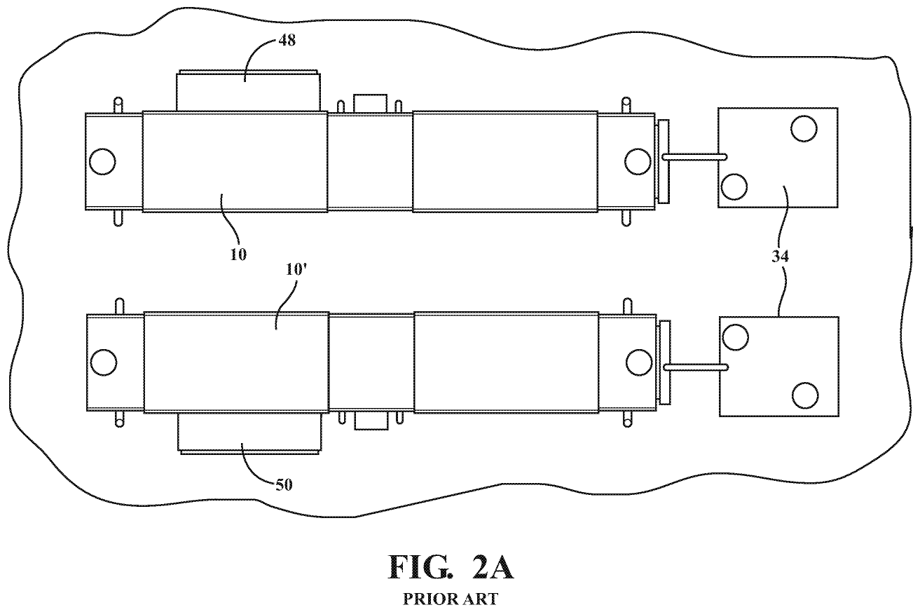

It is also understood that the non-limiting arrangement of FIG. 9 can envision a tank skid and washer being delivered as separate items, along with the separate provision of an additional pump and filter system which can be installed in a number of varying configurations. As previously described, it is also envisioned that the remote filtration system can be piped to service dual washers 100, such as which can be further arranged in a side-by-side configuration as shown in the prior art depiction of FIG. 2.

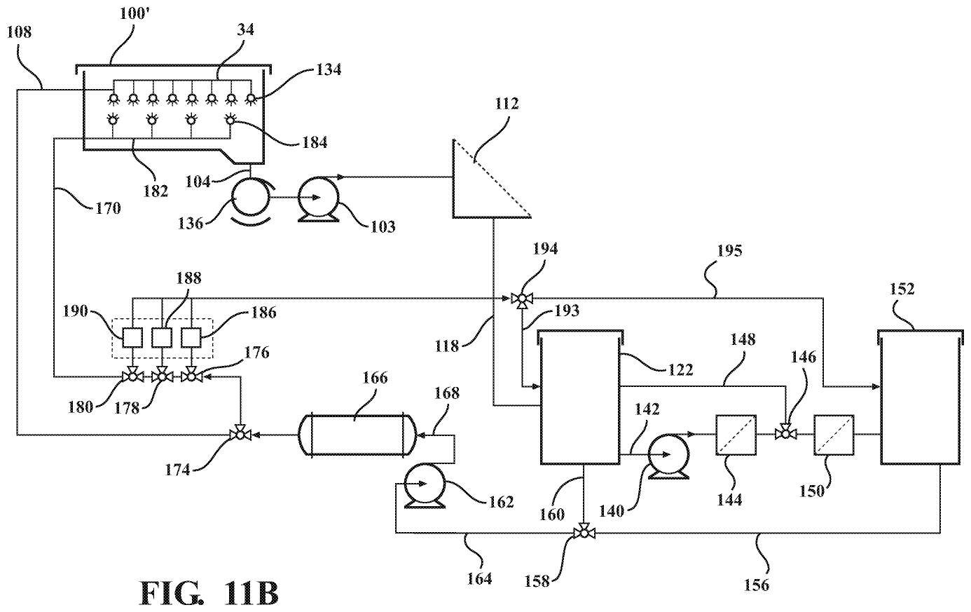

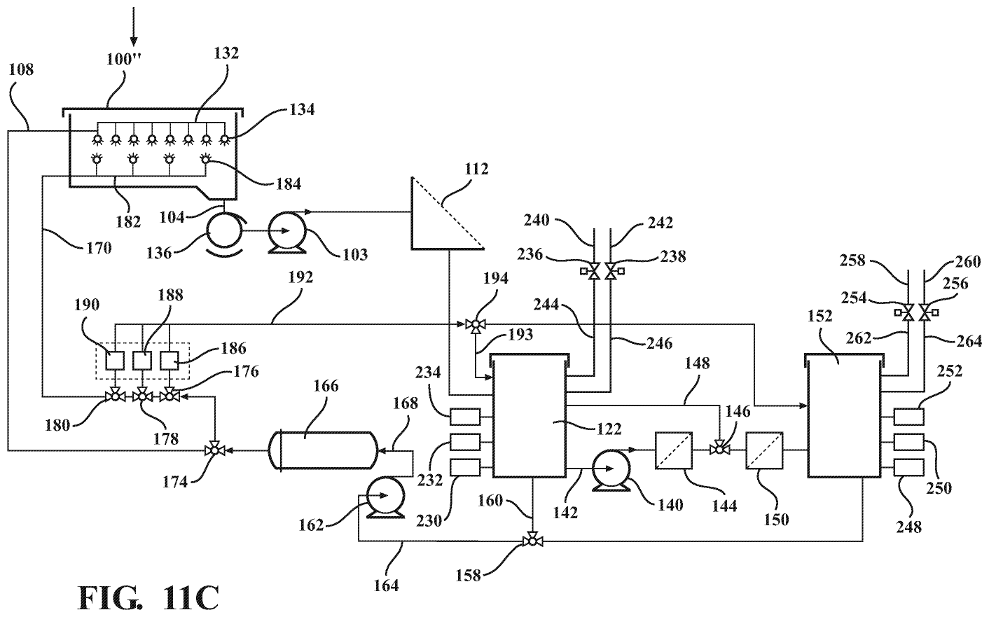

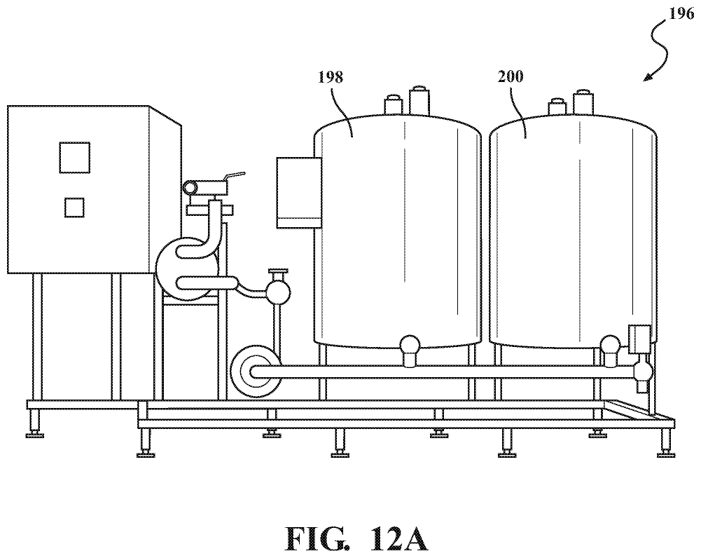

FIG. 11A further provides a diagrammatic illustration of a wash water circulation, filtration, reconditioning and re-use system according to one non-limiting variant which is similar to that previously described in assembly fashion in FIG. 10B however can include varying and alternating components for providing remote waste water filtration, reconditioning and rerouting back to the washer inlet (spray bars and clean-in-place architecture). For purposes of the description of the related diagrammatic views of FIGS. 11A-11B, common elements previously described will be labeled similarly, with additional or varying features also described.

The washer is again referenced at 100 in the diagrammatic illustration of FIG. 11A and representatively illustrates an interior conduit 132 feeding crosswise arranged spray bars 134 for washing the eggs (not shown) as they are conveyed through the washer interior via the array of crosswise extending spool bars. The lower gravity drain (at 102 in FIGS. 9 and 10B but not shown in FIG. 11A) feeds the outlet line 104 which is in turn fed through an optional rotary filter 136 for quick removal of the largest contaminants (whole eggs, large shell pieces, etc.) prior to the washer water sending pump 103 (again as shown in FIG. 10B) redirects the wash water to the parabolic or equivalent filter screen (again at 112).

Following the parabolic screen 112, the semi-filtered wash water is then redirected (again by line 118) to the wash water balance tank 122. A wash water balance tank level indicator can also be provided as shown at 138.

Multiple piping connections can exist from the balance tank 122 and, in the variant illustrated, include a filter pump 140 connected via an outlet line 142 (also termed as a second subset outlet extending from said first or main wash tank 122). In one non-limiting application, the pump 140 is intended to draw a continual portion of the wash fluid (typically some percentage less than the entire volume within the tank 122) which is supplied to a micro or ultra filter 144 (comparable to that depicted at 126 in FIG. 10B) for additional filtration such as again to remove fats, soil, bacteria, proteins and the like. This is also termed as a kidney or micro filtration closed loop and by which the system can operate to continuously remove a percentage of the debris, bacteria, proteins, fat and the like from the water while it is being continuously run through the washer in order to extend the useful operating cycle of the system well beyond that possible with existing localized filtration systems as depicted in the prior art.

A filter selection valve 146 is located at an outlet of the micro/ultra filter 144 and redirects some of all of the micro filtered fluid, via a line 148 (also termed as a second subset outlet from said first wash tank 122), back to the wash water balance tank 122. Additionally or alternatively, the filter selection valve 146 redirects a further portion of the substantially filtered water to a further located nano/reverse osmosis (RO) filter 150, this further operating to provide either or both of water softening, decolouring and micro pollutant removal, as well as in the instance of an RO component, utilizing a semipermeable membrane to remove ions, molecules and larger particles from the water.

Once passing through the nano/RO filter 150, the water can be further redirected to a filtered water balance tank 152, such further including a separate tank level indicator 154. To the extent that replacement additives of detergent, anti-foaming agents and ph boosters are still required, these can be added at either of the main wash water tank 122 or optionally or additionally at the filter water balanced tank 152, in the latter instance prior to the treated contents being drawn, by an outlet line 156 communicated via a second tank selection valve 158, either back to the first wash water balance tank 122 (via conduit 160) or a wash water return pump 162 (via a further directional conduit 164 extending from a further outlet of the valve 158 alternate to the wash water redirection conduit 160.

A wash water heat exchanger 166 can be optionally provided and which is communicated via a conduit 168 extending from an outlet of the wash water return pump 162. In this manner, the water can be reheated to the desired temperature range (typically but not limited to a range of 100-120° F. to provide adequate washing performance of the eggs when issued through the spray bars without cooking or otherwise undesirably affecting them).

Following the continual partial treatment of the wash fluid in the manner described above, and at the time in which an entire volume of the wash water must be recycled or replaced, one non-limiting operational protocol contemplates the egg wash production valve 146 to be switched so that filter pump 140 transfers all of the water from the tank 122 through the filters 144 and 150 (via filter selection valve 146) to filter water balance tank 152. The water at this point can be disposed of or, if desired, utilized in a final clean in place or rinse operation through the washer 100 and prior to being finally dumped. As previously described, the architecture shown in FIG. 11A can be easily reconfigured for use in a dual or other multiple washer arrangement, such as which can be further utilized in large volume egg processing (washer/dryer/grading/packaging) line operations.

Referring now to FIG. 11B a modified diagrammatic illustration is provided largely similar to that shown in FIG. 11A and depicting an additional clean-in-place function in use with the remote multi-stage filtration and reconditioning system according to further variant of a washer 100′. For purposes of discussion of FIG. 11B, identical components presented in the diagram of FIG. 11A are repeated without further discussion.

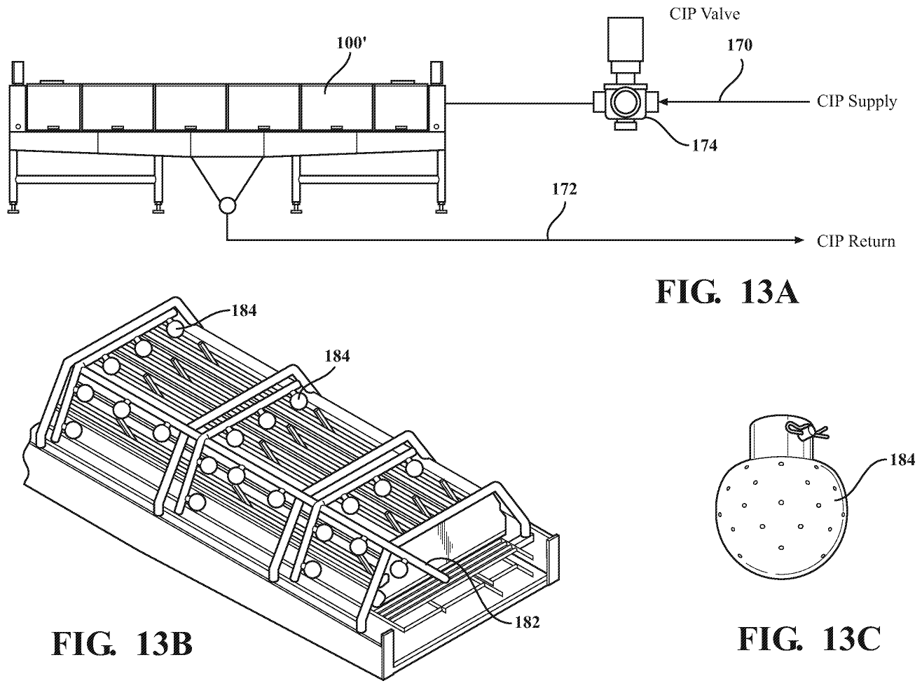

As shown in FIG. 11B, an additional clean-in-place (CIP) system is provided for cleaning the interior of the washer (again shown reconfigured at 100′) during periods of maintenance when eggs are not being conveyed through and the spray bars 134 are operating. As additionally shown in FIG. 13, the clean in place (CIP) wash architecture incorporated into the washer includes each of a CIP supply line 170 and lower drain/return line 172 (typically the same as the drain line 104 for the main egg wash cycle).

A CIP valve 174 is shown in each of FIGS. 11B and 13A and, depending upon its position, either provides fluid via the main return line 108 to the egg washer spray bars 134 in the normal operation or redirects the fluid in a CIP operation to a series of CIP supply circuits 176, 178 and 180. In one variant, the outlet of the third series located supply circuit 180 redirects fluid (via supply line 170) back to a CIP line 182 located in the reconfigured washer 100′ for delivery to the individual CIP spray nozzles 184, which is further shown in related FIGS. 13B-13C and which can include a ball or sphere like shape which includes a plurality of perforations for redirecting wash spray across all of the proximate interior surfaces of the washer 100′ to be cleaned and for cleaning in place of brushes and any other inside components and walls of the washer.

Referencing again the diagrammatic architecture of the operational configuration of FIG. 11B, the CIP supply circuits 176, 178 and 180 may each further communicate with a CIP systems connection, these shown respectively at 186, 188 and 190 however which are understood to be variable (more or less) in number. A clean in place return line 192 is fed by an outlet of each of the CIP system connections 186, 188, 190 and can redirect fluid to a CIP return tank select valve 194, which is in turn connected to either the main wash water tank 122 (via inlet line 193) or the filtered water balance tank 152 via a further conduit 195.

According further to the optional CIP operation, and at the end of the typical wash cycle in which the water has been continuously passed through the washer spray bars 134 as previously described in FIG. 11A along with a strained portion of the wash water being separated, micro filtered and (as needed) treated before recombining, the fluid is then once again emptied from the wash tank 122 into the filter tank 152. At this point, the CIP supply valve 174 switches to activate the CIP supply circuits 176, 178 and 180.

At this point, the wash water return pump 162 is activated to push the water through the CIP supply line 170 and through the washer interior CIP architecture (this represented schematically again into conduits 182 and out through clean in place spray nozzles 184 which can be located offset from the egg washing spray bars 34 and nozzles 134). Following this, the water is drained from the washer as previously described and directed, via wash water sending pump 103, to the wash water balance tank 122 (such a via the parabolic screen 112 and following which the fluid can be charged with additional detergents or other additives to continue the CIP operation for the desired period).

Upon all of the water being delivered from the filtered water balance tank 152, the tank selection valve 158 can be switched to redirect to the main wash water tank 122, such as which can be charged with additional detergents to maintain the CIP operation while the filter balance tank 152 is refilled with fresh rinse water. The CIP supply valves 176, 178 and 180 likewise redirect a portion of the fluid back to the main wash tank 122 (consistent with the main wash cycle as previously described) for receiving detergent additives as needed during the CIP operation.

After each circuit 186, 188 and 190 completes its cycle, tank selection valve 158 and CIP return tank select valve 194 operate to switch to a CIP rinse cycle for cleaning each of the CIP circuits and then to return the rinse water to the filtered balance tank 152 for emptying or future reuse. In this manner, the operator can extend the useful of a given volume of wash fluid beyond that possible with prior art wash and filter assemblies incorporated directly into the washer, with the option to dump the washer fluid at the end of a given life cycle of operation or reuse the water in a clean-in-place operation or a separate rinse cycle operation (such occurring during a next day initial operation prior to resuming normal egg washing).

FIG. 11C is a further modified diagrammatic illustration of a washer variant (at 100″), in comparison to that shown at 100′ in FIG. 11B, and depicting additional monitoring features associated with each of the wash water balance tank and filtered water balance tank. For purposes of this figure, identical features from FIG. 11B are repetitively numbered with description being limited to the newly added components.

A series of wash water balance tank level indicator 230, wash water balance tank temperature sensor 232 and PH/conductivity/turbidity sensor 234 are provided in communication with the wash water balance tank 122. A wash tank chemical supply valve 236 and wash tank water supply valve 238 are provided, with a chemical supply 240 communicating with the chemical supply valve 236 and a potable water supply 242 communicating with the tank water supply valve 238, with respective outlet lines 244 and 246 extending from the valves 236/238 and feeding to the wash water balance tank 122.

During initial conditioning to wash eggs, the wash water tank 122 is filled with clean water by potable water supply valve 238, following which the tank 122 is charged with the desired egg wash chemicals via the wash tank chemical supply valve 236 and then heated to its desired set point (such as again without limitation being in a range at or below 120° F. At this point, the level 230, temperature 232 and chemical 234 monitor sensors ensure the proper functioning the wash water balance tank 122.

The filtered water balance tank 152 is likewise communicated with each of a filtered water balance tank level indicator 248, filtered water balance tank temperature sensor 250 and PH/conductivity/turbidity sensor 252. A filter tank chemical supply valve 254 and filter tank water supply valve 256 are provided, with a further chemical supply 258 communicating with the chemical supply valve 254 and a potable water supply 260 communicating with the filter tank water supply valve 256, with respective outlet lines 262 and 264 extending from the valves 254/256 and feeding to the wash water balance tank 152.

The filtered wash water tank 152 is filled with and additional volume clean water by potable water supply valve 256, following which the filter balance tank 152 is charged with the desired egg wash chemicals via the filter tank chemical supply valve 254. At this point, the level 248, temperature 250 and chemical 252 monitor sensors ensure the proper functioning the filter water balance tank 152.

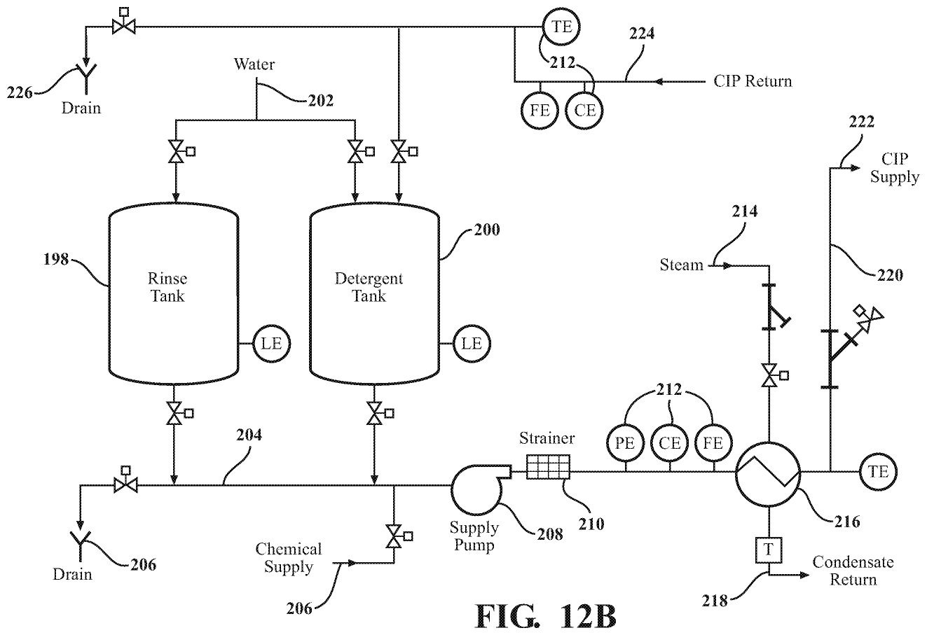

FIGS. 12A and 12B present both environmental assembly and related schematic illustrations, generally at 196, of a further embodiment of the present invention utilizing a dual tank clean in place system (see rinse tank 198 and detergent tank 200 as further described in FIG. 12B), such as by itself known in the existing art. Such a system can compensate for many food process facilities which may have limited water utilities (including those located in more arid climates) and which must recover and reuse wash solutions over extended use cycles in order to operate efficiently and in cost-effective and sustainable fashion.

In the instance of a two tank CIP system, the detergent wash can be reused to provide water savings and to allow for faster wash cycle times due to the recovered solution which may already be heated and adequately charged with the necessary detergents/chemicals or other additives which as which may be required to compensate for local water conditions (e.g. hard or soft water or the existence of other additives or deposits).

As further shown in the abbreviated schematic of FIGS. 12B, the pair of rinse 198 and detergent 200 tanks are shown fed by an water inlet 202 via inlet pipes and valving (such not requiring separate callout and referencing again the previous descriptions of FIGS. 9-11B). It is further understood that the rinse 198 and detergent 200 tanks can be analogous in operation to the wash water balance tank 122 and filtered water balance tanks 152 depicted in FIGS. 11A-11B. The outlets of the rinse 198 and detergent 200 tanks are fed to a common line 204, which in turn includes valving for either dumping the fluid, via drain 206 at an end of an operating cycle.

Alternatively, the common line 204 redirects the collected fluid from the tanks 198 and 200 along with a separate chemical/detergent supply additive 206 to a supply pump 208. An outlet of the pump 208 directs the recombination of fluid through a strainer 210 and, subsequently, through any collection of indicators not limited to those associated with flow, pressure or conductivity, and as shown at 212.

A separate steam input 214 is noted (such as which can be fed by a boiler or the like) and which is redirected into an expander 216 concurrent with the filtered wash fluid in order to remove a disposal portion through a condensate return 218, along with a separate redirection line 222 for re-circulating the previously particle and steam-filtered fluid back to the washer for any of a wash, rinse or OP cycle. Clean in place return line is also shown at 224 and, along with additional flow, pressure or conductivity control (again at 212), also includes valving to either return fluid to the detergent tank 200 or dump through drain 226.

It is also envisioned that the dual tank system disclosed can further be integrated into other plant operations not limited to the washer and including such as clean-in-place operations for other equipment by which additional fluid lines can extend to other articles of equipment with additional operational and infrastructure savings.

It is also envisioned that the washer filtration and reuse systems, as disclosed in any of the embodiments disclosed herein, can also be utilized with any other food/edible processing operation outside of shell egg processing, such including any type of poultry or other edible washer/processing operation. Beyond edibles, it is further envisioned that the present filtration system can also be utilized in other washer style operations directed for use with any style of industrial parts (automotive, tooling, etc.) for which a continuous washer operation is desired.

The present invention provides numerous advantages over conventional egg washers by avoiding the necessity of integrating the washer reservoir, pumps, and filters directly into the washer structure (typically the lower half of the washer below the egg supporting conveyor or egg spool bars. By the present construction, the ability to relocate the filtration and treatment functions away from the washer (via the outlet and return fluid lines) allows for longer wash water cycles (potentially greater than the four hours currently stipulated by USDA regulations) along with more efficient filtration of the water as provided by the multi-stage filters and the continuous kidney loop function for additionally fine filtering the subset volume of fluid from the wash water balance tank for redirection from the filtered water balance tank back to the washer. In this manner, the present system provides both extended life of a given volume of wash fluid, with reduction in the cost of additives/detergents by virtue of the wash fluid being utilized for a longer cycle, along with the improved filtration techniques facilitating removal of proteins, fats, bacteria and the like to reduce the amounts of additional detergent which need to be added during a given operational period.

In one non-limiting operational protocol, and following conclusion of an operational wash cycle in which the fluid is continuously filtered and then recirculated through the egg washer spray bars, the present system further enables the washer fluid to be utilized in a concluding clean-in-place or rinse cycle of the washer, such prior to removal/recycling of the given volume of fluid. In this manner, both the cost of the water volume used in the operational egg washing and non-operational clean in place washer interior cleaning is reduced, as is the recycling or disposal costs of the fluid following completion of its life cycle.

Other advantages include reduced fabrication cost, reduced installation cost and time, along with the requirement of less utility inputs such as electricity and water, for operating the washer, improved reliability through the reduction of controls and mechanical components such as which are located in the harsh operating environment of the washer. Reductions in cleanup time are also obtained (less tanks, filters and piping to clean around the washer since the prior art architecture is replaced by a simplified network of intake and outlet/drain pipes).

The collection tank arrangement provided by the proposed system provide both a simplified design which is easier to clean, as well as additionally providing for clean in place cleaning of the washer interior in addition to normal egg spray bar operation. It is also envisioned that the storage/cleaning tanks can, additional to steel/aluminum, be also constructed of alternate materials not limited to plastic and composites thereof, as well as providing enhanced insulation options for maintaining optional wash or OP operations. Hygienic design requirements associated with locating the washer/filtration cycle on the washer body itself typically limit the selection of materials which can be utilized in the construction of the washer integrated tanks.

It is also noted that, by removing the filtration function from the washer (thus freeing the designer from the space limitations associated with washer integrated networks), more extensive filtration can be employed. In contrast, current washer filtration methods (such as strainer or rotary screen designs) are limited by available space within the washer and, as a result, may often have to be custom designs with attendant increases in cost and complexity.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

We claim:

1. A system for filtering and recirculating a wash fluid associated with a piece of equipment, said system comprising:
an outlet line extending from a drain location of the piece of equipment for communicating the wash fluid from the equipment to a first stage particulate removal filter;
a further conduit extending from an outlet of said first stage filter for communicating the wash fluid to a first tank;
a second stage filter in communication with a first outlet extending from said first tank for continuously redirecting a subset portion of said fluid through said second stage filter; and
a return conduit extending from an outlet side of said second stage filter which is communicated with a second outlet extending from said first tank at a rejoining location for redirecting a recombined fluid back to an intake line for redelivery to the piece of equipment.

2. The system as described in claim 1, said first stage filter further comprising at least one of a rotary filter or a parabolic screen filter.

3. The system as described in claim 1, further comprising a wash water sending pump located between said drain location and said first stage filter.

4. The system as described in claim 1, said first tank further comprising a wash water balance tank having a tank level indicator, a temperature sensor and a PH/conductivity/turbidity chemical sensor.

5. The system as described in claim 1, said first outlet from said first tank further comprising first and second subset outlets, with said first subset outlet communicating fluid to an outlet side of said second stage filter and said second subset outlet redirecting wash fluid through a filter pump in communication with an inlet of said second stage filter.

6. The system as described in claim 5, said second subset outlet further comprising a filter selection valve positioned on an outlet side of said second stage filter, said first subset outlet communicating with said filter selection valve.

7. The system as described in claim 6, further comprising a second filtered water balance tank in communication with an outlet of said filter selection valve.

8. The system as described in claim 7, further comprising a third stage filter located on an outlet side of said filter selection valve prior to said second filtered water balance tank.

9. The system as described in claim 1, further comprising a tank selection valve at said rejoining location, an outlet of said rejoining location communicating said recombined fluid to a wash water return pump.

10. The system as described in claim 9, further comprising a wash water heat exchanger located at an outlet of said wash water return pump, said heat exchanger in communication with said intake line extending to said inlet location of the equipment.

11. The system as described in claim 7, the piece of equipment further including a shell egg washer having a fluid network of spray bars extending between said intake and outlet lines.

12. The system as described in claim 11, the shell egg washer further including a clean in place architecture which is communicated with said intake line for cleaning an interior of the shell egg washer.

13. The system as described in claim 12, further comprising a clean in place supply line in combination with a clean in place valve extending in a second intake line extending parallel to said first input line to the egg washer.

14. The system as described in claim 13, further comprising a plurality of supply circuit valves associated with said clean in place architecture and extending between said second washer intake line and a clean in place return line extending to a clean in place return tank select valve in communication with said second filtered water balance tank.

15. The system as described in claim 13, said clean in place architecture further comprising a plurality of spherical shaped elements in communication with said clean in place supply line within the washer for distributing fluid in a non-operational maintenance phase to clean an interior of the washer.

16. The system as described in claim 7, further comprising a detergent additive at one of said first and second tanks.

17. The system as described in claim 7, said filtered water balance tank further comprising each of a tank level sensor, a temperature sensor and a PH/conductivity/turbidity chemical sensor.

18. The system as described in claim 7, each of said wash water balance tank and said filtered water balance tank further comprising a chemical supply valve and a potable water supply valve communicating with an inlet location.

19. A system for filtering and recirculating a wash fluid associated with a piece of equipment, said system comprising:
an outlet line extending from a drain location of the piece of equipment for communicating the wash fluid from the equipment to a first stage particulate removal filter;
a further conduit extending from an outlet of said first stage filter for communicating the wash fluid to a first tank;
a second stage filter in communication with a first outlet extending from said first tank for continuously redirecting a subset portion of said fluid through said second stage filter;
a return conduit extending from an outlet side of said second stage filter which is communicated with a second outlet extending from said first tank at a rejoining location for redirecting a recombined fluid back to an intake line for redelivery to the piece of equipment; and
said first outlet from said first tank further including first and second subset outlets, with said first subset outlet communicating fluid to an outlet side of said second stage filter and said second subset outlet redirecting wash fluid through a filter pump in communication with an inlet of said second stage filter.

20. A system for filtering and recirculating a wash fluid associated with a piece of equipment, said system comprising:
an outlet line extending from a drain location of the piece of equipment for communicating the wash fluid from the equipment to a first stage particulate removal filter including at least one of a rotary filter or a parabolic screen filter;
a wash water sending pump located between said drain location and said first stage filter;
a further conduit extending from an outlet of said first stage filter for communicating the wash fluid to a first tank;
said first tank further including a wash water balance tank having a tank level indicator, a temperature sensor and a PH/conductivity/turbidity chemical sensor;
a second stage filter in communication with a first outlet extending from said first tank for continuously redirecting a subset portion of said fluid through said second stage filter;
a return conduit extending from an outlet side of said second stage filter which is communicated with a second outlet extending from said first tank at a rejoining location for redirecting a recombined and reconditioned fluid back to an intake line for redelivery to the piece of equipment; and
a clean-in-place supply line incorporated into the piece of equipment and connected to said return conduit by a clean in place valve, a networked plurality of pipes and nozzle sprayers distributed across an interior of the equipment and, upon actuating said clean in place valve, spraying fluid to clean the equipment interior.
